(19) United States
(12) Patent Application Publication
(10) Pub. No.: US 2012/0207395 A1
(43) Pub. Date: Aug. 16, 2012

(54) MEASURING DEVICE SET AND METHOD FOR DOCUMENTING A MEASUREMENT

(75) Inventors: Martin Stratmann, Freiburg (DE); Jan-Friso Evers-Senne, Lenzkirch (DE)

(73) Assignee: TESTO AG, Lenzkirch (DE)

(21) Appl. No.: 13/369,674

(22) Filed: Feb. 9, 2012

(30) Foreign Application Priority Data
Feb. 9, 2011 (DE) 102011010722.3

(51) Int. Cl. G06K 9/46; G06K 7/10; G06K 7/12

(52) U.S. Cl. 382/195; 235/468; 235/454

(57) ABSTRACT

A measuring device set (1) with a measuring device (2) and markers (6), that include an identification region (10) and a data region (7), containing the information to be read out, on the markers (6). The measuring device (2) has a recording unit (14), for recording (15) the marker (6) during the measurement (3) or in addition to the measurement (3), and an evaluation unit, for identifying the identification region (10) and for extracting the data from the data region (7) which is in a predetermined relative position to the identification region (10).

### CROSS-REFERENCE TO RELATED APPLICATIONS

This application claims the benefit of German Patent Application No. 10 2011 010 722.3, filed Feb. 9, 2012, which is incorporated herein by reference as if fully set forth.

### BACKGROUND

The invention relates to a measuring device set, comprising a measuring device and a marker, applied on an examination object, the measuring device being designed to measure at least one physical measurement variable of the examination object.

The measuring devices of such measuring device sets are generally embodied as hand-held measuring devices and are used to carry out inspections.

In the case of such inspections, it is important that the data obtained after the inspection is concluded can be documented and stored or provided in a traceable fashion.

The invention furthermore relates to a method for documenting a measurement.

### SUMMARY

The invention is based on the object of making it easier to carry out an inspection.

According to the invention, in order to achieve this object, provision is made in the measuring device set described at the outset for the marker to have a data region with information in an optically evaluable code, for the marker additionally to have an identification region, for the measuring device to have a recording unit, which is designed to record an image of the examination object with the marker, for the measuring device to have an evaluation unit, which is designed to identify the identification region in the image, identify the data region relative to the identified identification region in the image and extract the information from the imaged data region. Here it is advantageous that data can be stored in the marker in the data region, which can be used or are required for the subsequent evaluation or documentation of the inspection. It is furthermore advantageous that this data region can be identified and read out in an automated fashion since the marker provides an identification region that can be used for identifying the data region and, more particularly, the position of the data region. Hence, the user is not required to carry out a special scanning movement or approach the examination object particularly closely for reading in the data region. Rather, the formation of a separate identification region makes it possible to identify and read out the data region in a recording made during the measurement at a distance. Thus, manual entries for documenting the performed measurement are no longer required, which significantly simplifies the subsequent documentation and thus, overall, carrying out the inspection.

In order to utilize a marker area that is as small as possible in a space-saving fashion, provision can be made for the identification region to adjoin the data region.

Provision can be made for the identification region to form an edge around the data region. Here it is advantageous for the data region to be delimited from the remaining surroundings in a simple fashion by the identification region. This is particularly advantageous in the case of an automated evaluation of the data region.

In one embodiment of the invention, provision can be made for the marker to be formed on a label, more particularly a self-adhesive label. Here it is advantageous that the marker can be applied to the examination object in a simple fashion.

Here it is particularly expedient for the identification region to be embodied as a polygon. By way of example, the identification region can be embodied as a quadrilateral. Here it is advantageous that the identification region thus offers corners and edges that can easily be identified by image evaluation or image processor. It is also advantageous that the edges and corners define reference points, in respect of which a data region can be called and read out.

In one embodiment of the invention, provision can be made for a corner detector to be formed in the evaluation unit. Hence, an identification region embodied as a polygon can easily be identified in an automated fashion. The corners identified by the corner detector can be used as reference points for specifying a relative position of the data region.

Provision can be made for the evaluation unit to be designed to determine a perspective distortion in the image. By way of example, this can be brought about by evaluating image positions of corners and/or edges of the identification region in the image. Here it is advantageous that read errors can be avoided or reduced when reading out the data region. One embodiment of the invention provides for the measuring device set to comprise a plurality of markers, the respective identification regions having identical embodiments with respect to one another and the data regions having embodiments that differ from one another. Here it is advantageous that the identification region can be identified in a standardized fashion for a multiplicity of markers.

In one embodiment of the invention, provision can be made for the measuring device to have a memory unit in which metadata associated with the information that can be encoded in the data region are kept available. Here it is advantageous that metadata that are relevant to the measured physical measurement variable can automatically be selected, recalled and assigned in the measuring device.

By way of example, provision can be made for the measuring device to have a documentation unit, which is designed to output at least one measurement result, measured by the measuring device, and metadata that are associated with the information.

It is particularly expedient for the automated detection of the content of the data region if the code is embodied as a light/dark code and/or as a color code.

By way of example, provision can be made for the coding to have pixels in a grid arrangement. The use of a 5×5 matrix of pixels has proven its worth for many applications.

In order to utilize a detector resolution of the recording unit in an optimum fashion, provision can be made for the identification region to have a structure size that equals the structure size of the code. Here, the structure size is understood to mean a characteristic length or area dimension that characterizes the size of the smallest shape unit used for coding or geometric shaping.

By way of example, provision can be made for the resolution of the code to be matched to the image resolution of the recording unit, particularly at an imaging distance defined by the distance between the measuring device and the examination object in a usage position.

In order to ensure a particularly reliable detectability of the information contained in the data region, provision can be made for the recording unit to be embodied as a VIS camera.

In many applications of the invention it is advantageous for the measuring device to be embodied as a thermal imaging camera. Here it is advantageous that radiation temperatures, more particularly in the form of a thermal image, can be measured as physical measurement variable, to which respectively associated metadata can be recalled from a memory unit and assigned.

In order to achieve the object in the case of a method of the type mentioned at the outset, provision is made for a marker with a data region and an identification region to be applied to an examination object, for an image to be recorded of the examination object with the marker, for the identification region to be identified in the image using an image processor, for information to be extracted in the image from the data region at a predetermined relative position to the identified identification region by using the image processor, for at least one measured value of a physical variable to be measured and for the information and/or metadata derived from the information to be associated with the measured value. Here it is advantageous that a user who carries out a prescribed or desired inspection need not additionally input the associated metadata, which should explain or accompany a subsequent documentation, but rather that these metadata are automatically associated with the respectively recorded measurement results from a database. This significantly reduces the effort for the subsequent work and hence the overall effort for carrying out the inspection.

According to one embodiment of the method according to the invention, provision can be made for the measurement and the image recording to be carried out simultaneously or with a small time-lag with respect to one another. Here, a small time-lag means that the time-lag is significantly shorter than, i.e. at most half or even at most a tenth of, the time-lag between two measurement measurements. Here it is advantageous that the association of the measurement result with an examination object carrying the marker is possible in a particularly reliable and low-error fashion.

In one embodiment, provision can be made for corner and/or edge detection to be carried out when identifying the identification region. Here it is advantageous that the marker can in a simple fashion be equipped with geometric structures such as corners and edges, which can be identified and evaluated in a particularly simple fashion in an automated image processing method.

Provision can be made for a perspective distortion of the image to be determined, preferably by the image processor, from the shape of the identified identification region in the image. Here it is advantageous that this can reduce or even completely avoid read errors when reading out the data region.

By way of example, provision can be made for a perspective distortion of the data region in the image to be compensated for, preferably by the image processor, before extracting the information.

The method according to the invention is preferably carried out using a measuring device set according to the invention.

### BRIEF DESCRIPTION OF THE DRAWINGS

The invention will now be described in more detail on the basis of an exemplary embodiment; however, it is not restricted to this exemplary embodiment. Further exemplary embodiments emerge by combining individual features or a number of features from the claims amongst each other and/or with individual features or a number of features of the exemplary embodiment.

In the drawings:

FIG. 1 is a schematic diagram of a measuring device set according to the invention for explaining the method according to the invention,

FIG. 2 is a perspective view from the front of the measuring device from FIG. 1,

FIG. 3 is a view showing a plurality of markers from the measuring device set according to the invention,

FIG. 4 is a view showing a marker with an identification region and an empty data region, and

FIG. 5 is a view showing a marker with an identification region and a filled data region.

### DETAILED DESCRIPTION OF THE PREFERRED EMBODIMENTS

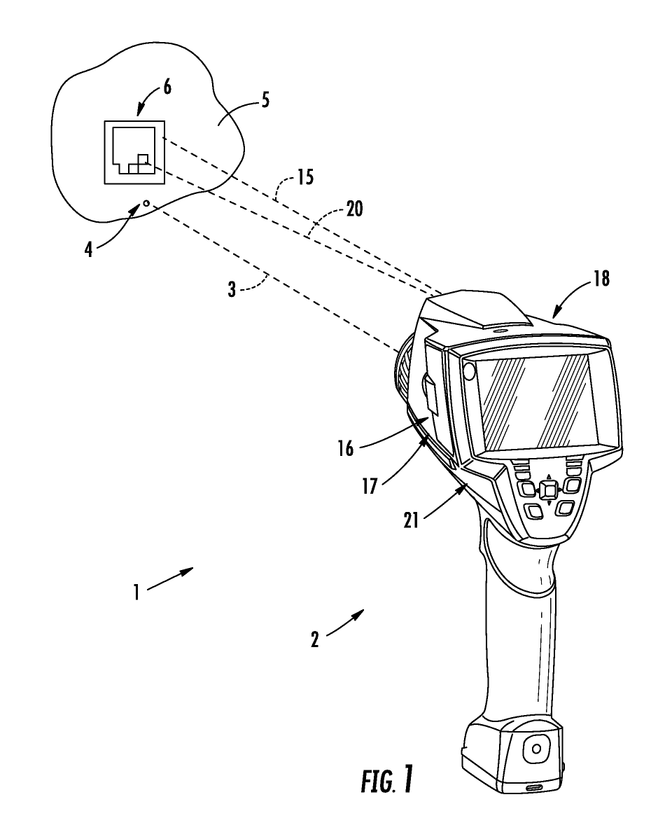

In a schematic diagram, FIG. 1 shows a measuring device set according to the invention, denoted by 1 as a whole. The measuring device set 1 comprises a measuring device 2, which is designed to measure 3 a physical measurement variable at a measurement point 4 of an examination object 5.

The measuring device set 1 furthermore comprises at least one marker 6, which is applied on the surface of the examination object 5, in the spatial vicinity of the measurement point 4.

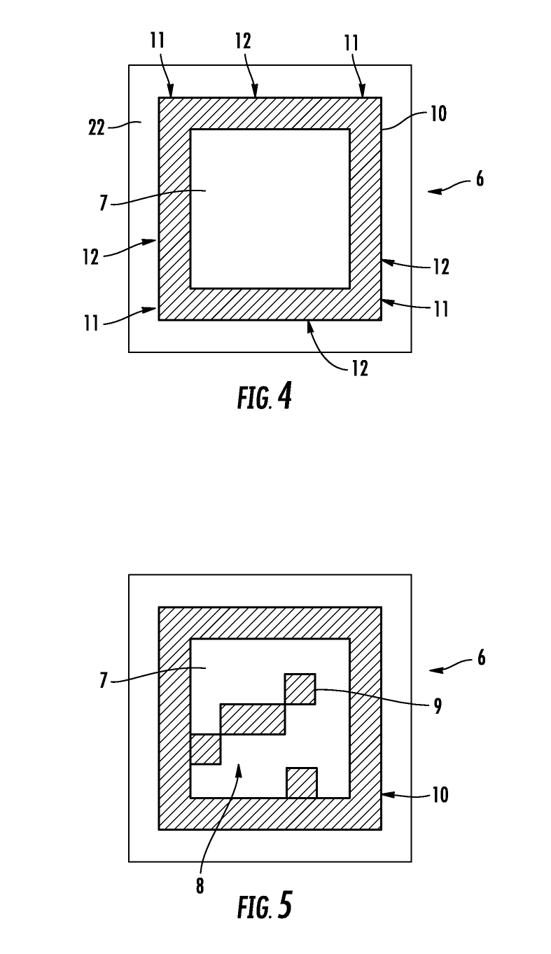

FIGS. 4 and 5 show individual illustrations of two different markers 6.

The marker 6 as per FIG. 5 has a data region 7, in which information is stored in a light/dark code 8 by means of pixels 9 of a pixel arrangement in the form of a 5×5 matrix.

By contrast, in the marker 6 according to FIG. 4, the corresponding data region 7 is empty.

Adjoining the data region 7 and forming an edge around the latter, an identification region 10 is formed on the markers 6 as a frame in the form of a quadrilateral.

This identification region 10 forms the corresponding geometric structure in the markers 6 as per FIGS. 4 and 5.

The polygonal—in this case quadrilateral—shape of the identification region 10 has corners 11 and edges 12 that connect these corners.

In other polygonal shapes, provision is made for a deviating number of corners 11 and edges 12. In one exemplary embodiment, the identification region 10 can also be embodied as a circle.

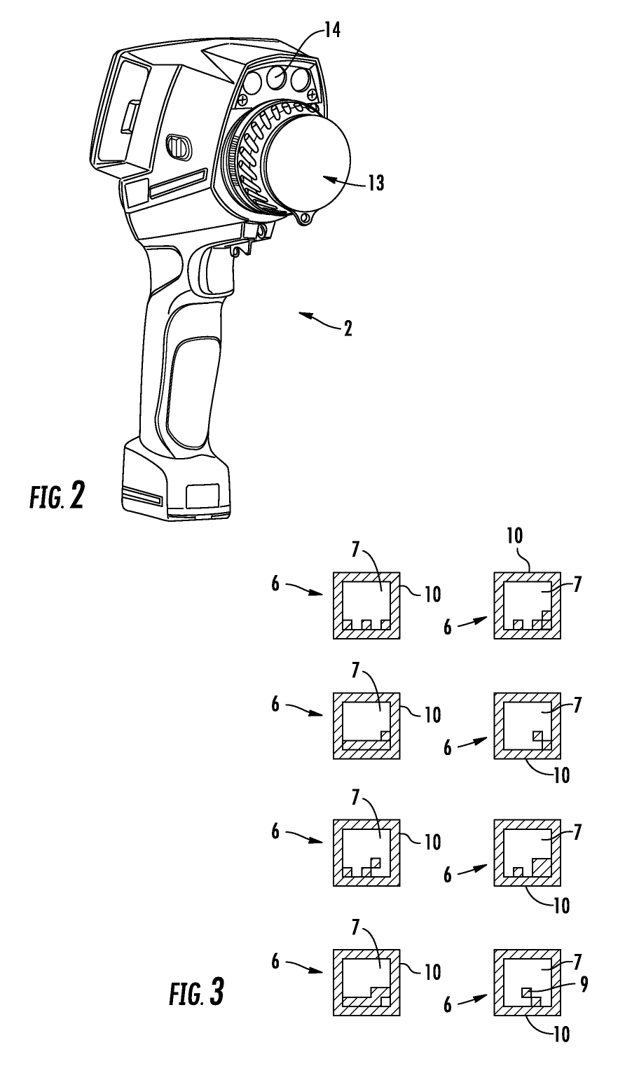

The measuring device 2, illustrated in a perspective view from the front in FIG. 2, has a measuring detector 13 for capturing a physical measurement variable.

In the presented exemplary embodiment, the measuring device 2 is embodied as a thermal imaging camera with an IR radiation detector, embodied in a manner known per se, as a measuring detector 13.

The measuring device 2 furthermore has a recording unit 14, by which an image of the marker 6 with the examination object 5 or with parts of the examination object 5 is recorded 15 at the same time as the measurement 3.

An evaluation unit 16, in which an image processor 17 are realized, is formed in the measuring device 2.

The image processor 17 comprise corner and edge detectors, which are used to identify, in the image, the identification region 10 on the marker 6. As soon as the identification region 10 is identified, the marker 6 is identified and the data region 7, which is at a predetermined relative position, can be read out in respect of the identified identification region 10.

To this end, the individual pixels 9 of the light/dark code 8 are identified, and information is extracted from the data region 7.

Metadata are stored in a memory unit 18 in the interior of the measuring device 2 and these are associated with the data and information that can be extracted from the data regions 7 of the markers 6.

FIG. 3 shows a plurality 19 of markers 6, which respectively have an identical identification region 10 and differently occupied data regions 7.

It can clearly be seen from FIG. 3 that a 5×5 matrix of pixels 9 is used for the light/dark code 8—which can also be embodied as a color code.

The extracted information or the metadata stored in the memory unit 18 for the extracted information is/are associated with the measured value that was obtained in the measurement 3.

In general, the examination object 5 has an irregularly shaped surface.

As a result, the marker may not be aligned in a defined fashion with respect to the visual axis 20 of the recording unit 14. Thus, as a result, the geometric shape of the identification region 10 will have a perspective distortion in the recording 15 made by the recording unit 14.

However, since the geometric shape of the identification region 10 is known, the perspective distortion can be compensated for in the evaluation unit 16 by determining the image positions of the corners 11 and edges 12 of the identification region 10 in the image. This makes it possible to establish the deviation of the determined geometric shape of the identification region 10 in the image from a geometric shape stored in a memory unit. The perspective distortion can be derived from the deviation.

The measuring instrument 2 has a documentation unit 21 in the form of a display and/or in the form of a data interface, which is designed to output at least one measurement result, measured by the measuring device 2, and metadata which are encoded in the data region 7 of the marker 6 applied onto the examination object 5.

The markers 6 shown in FIGS. 3 to 5 are printed onto a label 22, which, as a self-adhesive label, can easily be applied onto the examination object 5.

The size of the pixel 9 in the data region 7 as smallest unit of information predetermines a structural size of the data region 7, which equals the width of the identification region 10 that encircles the data region 7 as a frame.

These structural sizes are selected such that at the imaging distance between measuring device 2 and examination object 5 typically present in the usage position, the structures of the identification region 10 and the data region 7 do not drop below the resolution of the recording unit 14.

In the case of the measuring device set 1 with a measuring device 2 and markers 6, that include an identification region 10 and a data region 7, which contains the information to be read out, on the markers 6, wherein the measuring device 2 has a recording unit 14, for recording 15 the marker 6 during the measurement 3 or in addition to the measurement 3, and an evaluation unit, for identifying the identification region 10 and for extracting the data from the data region 7 in a predetermined relative position to the identification region 10.

1. A measuring device set (1), comprising a and-held measuring device (2) and a marker (6) that is adapted to be applied on an examination object (5), the measuring device (2) being designed to measure (3) at least one physical measurement variable of the examination object (5), the marker (6) includes a data region (7) with information in an optically evaluable code (8) and an identification region (10), the measuring device includes a recording unit (14), which is designed to record (15) an image of the examination object (5) with the marker (6), and an evaluation unit (16), which is designed to identify the identification region (10) in the image, identify the data region (7) relative to the identified identification region (10) in the image, and extract the information from the imaged data region (7).

2. The measuring device set (1) as claimed in claim 1, wherein at least one of: the identification region (10) adjoins the data region (7), the identification region (10) forms an edge around the data region (7), or the marker (6) is formed on a label (22).

3. The measuring device set (1) as claimed in claim 1, wherein the label (22) is a self adhesive label.

4. The measuring device set (1) as claimed in claim 1, wherein the identification region (10) is embodied as a polygon.

5. The measuring device set (1) as claimed in claim 4, wherein the evaluation unit includes at least one of a corner detector or is designed to determine a perspective distortion in the image by evaluating image positions of at least one of corners (11) or edges (12) of the identification region (10) in the image.

6. The measuring device set (1) as claimed in claim 1, wherein the measuring device set (1) comprises a plurality (19) of the markers (6), with the respective identification regions (10) having identical embodiments with respect to one another and the data regions (7) having embodiments that differ from one another.

7. The measuring device set (1) as claimed in claim 1, wherein the measuring device (2) further comprises a memory unit (18) in which metadata associated with the information that can be encoded in the data region (7) are kept available.

8. The measuring device set (1) as claimed in claim 7, wherein the measuring device (2) further comprises a documentation unit (21), which is designed to output at least one measurement result, measured by the measuring device (2), and metadata that are associated with the information.

9. The measuring device set (1) as claimed in claim 1, wherein the measuring device (2) further comprises a documentation unit (21), which is designed to output at least one measurement result, measured by the measuring device (2), and metadata that are associated with the information.

10. The measuring device set (1) as claimed in claim 1, wherein the optically evaluable code is embodied as at least one of a light/dark code (8), a color code, or pixels (9) in a grid arrangement.

11. The measuring device set (1) as claimed in claim 10, wherein the optically evaluable code comprises the grid arrangement having a 5×5 matrix.

12. The measuring device set (1) as claimed in claim 1, wherein at least one of the identification region (10) has a structure size that equals the structure size of the code (8) or a resolution of the code (8) is matched to an image resolution of the recording unit (14).

13. The measuring device set (1) as claimed in claim 12, wherein the resolution of the code (8) is matched to the image resolution of the recording unit (14) at an imaging distance defined by a distance between the measuring device (2) and the examination object (5) in a usage position.

14. The measuring device set (1) as claimed in claim 1, wherein the recording unit (14) comprises a VIS camera.

15. The measuring device set (1) as claimed in claim 14, wherein the measuring device (2) is embodied as a thermal imaging camera.

16. The measuring device set (1) as claimed in claim 1, wherein the measuring device (2) is embodied as a thermal imaging camera.

17. A method for documenting a measurement (3), comprising applying a marker (6) with a data region (7) and an identification region (10) to an examination object (5), recording an image of the examination object (5) with the marker (6), identifying the identification region (10) in the image using image processor (17), and extracting information in the image from the data region (7) at a predetermined relative position to the identified identification region (10) using the image processor (17), wherein at least one measured value of a physical variable is measured and at least one of the information or metadata derived from the information are associated with the measured value.

18. The method as claimed in claim 17, wherein the measurement (3) and the image recording (15) are carried out simultaneously or with a small time-lag with respect to one another, wherein at least one of corner or edge detection is carried out when identifying the identification region (10), wherein at least one of a perspective distortion of the image is determined by image processor (17), from a shape of the identified identification region (10) in the image or a perspective distortion of the data region (7) in the image is compensated for by the image processor, before extracting the information.
